(19) United States
(12) Patent Application Publication
(10) Pub. No.: US 2013/0044380 A1
(43) Pub. Date: Feb. 21, 2013

(54) LENS MODULE AND METHOD FOR MANUFACTURING THE SAME

(71) Applicants: Chi-Chih SHEN, Hsinchu County (TW); Hui-Hsuan CHEN, Hsinchu County (TW); Wei-Chung WANG, Hsinchu County (TW)

(72) Inventors: Chi-Chih SHEN, Hsinchu County (TW); Hui-Hsuan CHEN, Hsinchu County (TW); Wei-Chung WANG, Hsinchu County (TW)

(73) Assignee: PIXART IMAGING INC., Hsinchu County (TW)

(21) Appl. No.: 13/314,302

(22) Filed: Dec. 8, 2011

(30) Foreign Application Priority Data
Aug. 17, 2011 (TW) 100129458

(51) Int. Cl. G02B 7/02; B32B 37/12; B32B 38/10; B32B 37/14

(52) U.S. Cl. 359/811; 156/250

(57) ABSTRACT

A lens module is suitable for a wafer level process and works in collaboration with an image sensor. The lens module includes a substrate, a lens and a spacer. The lens is disposed on a surface of the substrate for concentrating a light. The spacer is disposed on the substrate and surrounds the lens to block the light from penetrating the substrate through a circumference of the lens. The substrate and the lens are made of a light transmissive material and the spacer is made of an opaque material for shielding a stray light coming from outside, thereby improving a sensing performance of the image sensor.

### CROSS-REFERENCE TO RELATED APPLICATIONS

This non-provisional application claims priority under 35 U.S.C. §119(a) on Patent Application No(s). 100129458 filed in Taiwan, R.O.C. on Aug. 17, 2011, the entire contents of which are hereby incorporated by reference.

### BACKGROUND

1. Technical Field

The disclosure relates to a lens module and a method for manufacturing the same, and more particularly to a lens module suitable for a wafer level process and working in collaboration with an image sensor and a method for manufacturing the same.

2. Related Art

In general, a lens module applied to a hand-held electronic device mainly includes an image sensor and a lens holder covering the image sensor. The lens holder has a rotary lens barrel, and the lens barrel has a lens set. When the lens set generates an image on the image sensor, the lens barrel may be rotated relative to the lens holder to change a distance between the lens set and the image sensor, thereby focusing a light on the image sensor. However, in this lens module, as the lens barrel is disposed inside the lens holder in a rotatable manner, the lens holder takes up a certain space in the lens module, thus the volume of the lens module is hard to be reduced and is not applicable to the hand-held electronic device in pursuit of being light in weight and small in size.

Therefore, a wafer level lens module emerges in the market recently. For example, the U.S. Pat. No. 7,564,496 has disclosed a wafer level lens module, which comprises an image capturing element and a spacer, a cover plate and a lens substrate with a lens sequentially stacked and adhered above the image capturing element. The spacer has an aperture that allows a light to pass through the lens to generate an image on the image sensor. The spacer, the cover plate and the lens substrate are all made of a glass material for the reason that a fracture may occur between the spacer and the cover plate or the lens substrate due to the mismatch of coefficient of thermal expansion (CTE) in the manufacturing process of the wafer level lens module. Meanwhile, the elements of the lens module are all made of an integrated circuit manufacturing process, so in comparison with the lens module in the prior art, the above-mentioned lens module has a small volume and is applicable to the small-sized electronic equipment such as a mobile phone.

However, in the above-mentioned wafer-level lens module, as the spacer is made of a light transmissive material, the spacer is not suitable for the quick mass production in manufacturing. Also, in the following processes of the wafer-level lens module, a light shielding element such as a sunshade or a housing is additionally required to wrap the spacer, the cover plate and the lens substrate; or, a photoresist paint is coated outside the spacer, the cover plate and the lens substrate, for shielding the stray lights from the ambient environment, thereby preventing the stray lights from being propagated to the image capturing element and influencing the image sensing performance and the image quality of the image capturing element.

Hence, the volume of the wafer level lens module is enlarged and meanwhile, the complexity and the difficulty in manufacturing of the wafer level lens module are increased, which causes the problem of the high manufacturing cost.

### SUMMARY

The disclosure discloses a lens module, suitable for a wafer level process and working in collaboration with an image sensor, which allows a light to appropriately concentrate on the image sensor through the lens module. In the wafer-level process, an opaque spacer may be added appropriately to work in collaboration with the lens for concentrating the light. Otherwise, the lens is disposed on a surface of a substrate and the spacer is disposed opposite to the lens and surrounds the lens to avoid blocking the lens from concentrating the light. Here, the substrate and the lens are made of a light transmissive material and the spacer is made of an opaque material.

The disclosure also discloses a method for manufacturing the lens module, suitable for manufacturing the aforementioned lens module. In the manufacturing method, a cutting process is performed after multiple lens modules are formed to separate and divide the multiple lens modules, which can reduce and simplify the complexity and the difficulty in manufacturing of the wafer level lens module.

### BRIEF DESCRIPTION OF THE DRAWINGS

The disclosure will become more fully understood from the detailed description given herein below for illustration only, and thus are not limitative of the present disclosure, and wherein:

FIG. 1 is a schematic cross-sectional view of an image capturing module according to a first embodiment of the disclosure;

FIG. 2 is a flow chart of manufacturing a lens module according to the first embodiment of the disclosure;

FIG. 3 is a schematic exploded view of the lens module according to the first embodiment of the disclosure;

FIG. 4 is a schematic combination view of a single lens module according to the first embodiment of the disclosure;

FIG. 5 is a schematic cross-sectional view of the single lens module according to the first embodiment of the disclosure;

FIG. 6 is a schematic cross-sectional view of a single lens module according to a second embodiment of the disclosure; and

FIG. 7 is a flow chart of manufacturing the lens module according to the second embodiment of the disclosure.

### DETAILED DESCRIPTION

The disclosure is a lens module and a method for manufacturing the same, thereby overcoming the deficiencies existing in the prior art that the light shielding element is additionally installed in the wafer level lens module and causes the problem that the volume of the wafer level lens module is hard to reduce and increases the complexity and the difficulty in manufacturing, which further causes the rising of the manufacturing cost.

A lens module and a method for manufacturing the same in the disclosure are suitable for a wafer-level process, and the lens module manufactured by the method is arranged in an image capturing module and works in collaboration with an image sensor. The drawings of the specification are shown for comprehensive purpose and those skilled in the art may understand how to apply the disclosure. Therefore, only necessary characteristics of the disclosure are shown and the elements and relative sizes in the drawings are used for exhibiting the necessary technical characteristics of the disclosure, and the sizes of the real products may be different, which is not intended to limit the application scope of the disclosure.

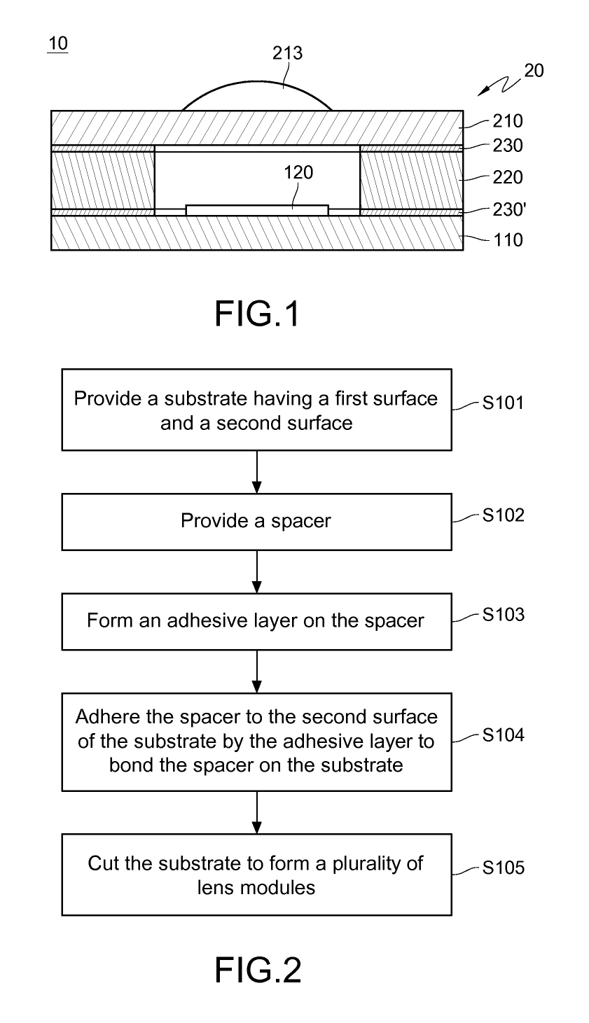

FIG. 1 is a cross-sectional schematic view of an image capturing module of the disclosure. The image capturing module 10 of a first embodiment of the disclosure includes a circuit board 110, an image sensor 120 and a lens module 20. The image sensor 120 is electrically disposed on the circuit board 110, the lens module 20 is disposed on the circuit board 110, and the lens module 20 and the image sensor 120 are located on the same side surface of the circuit board 110.

Moreover, the light in the disclosure may be a visible light and also an invisible light, so the light transmissive material of the disclosure refers to a material that allows the visible light and/or the invisible light to transmit. In some light emission applications, the invisible light cannot be perceived by human eyes, so the invisible light will not hurt the eyes of a user relatively.

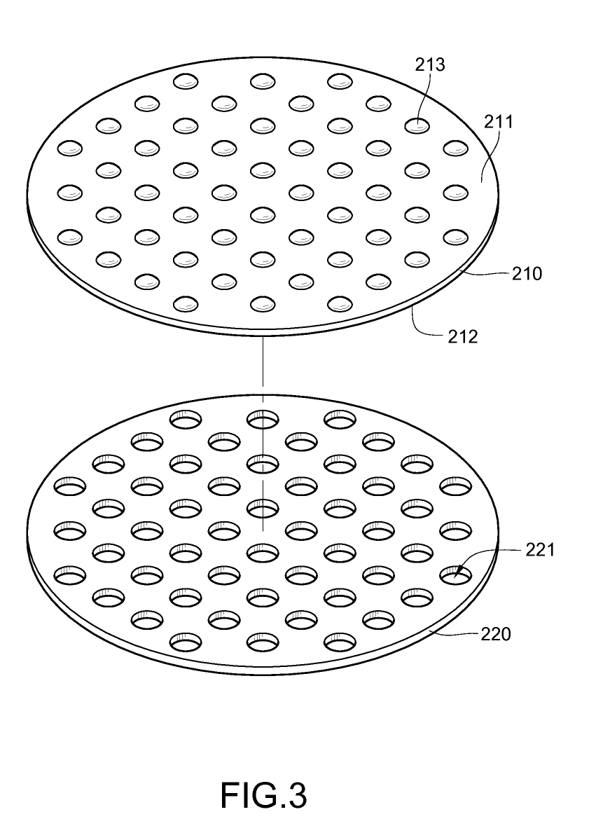

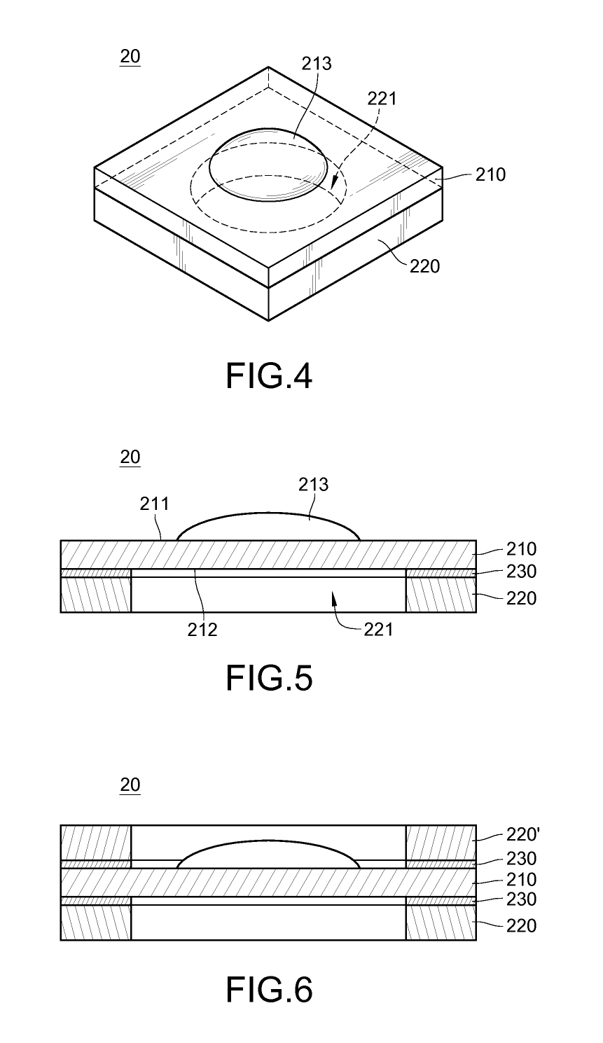

FIG. 1 to FIG. 5 respectively illustrate a flow chart of manufacturing the lens module and schematic views of the lens module of the disclosure. FIG. 2 is a flow chart of manufacturing the lens module according to the first embodiment of the disclosure. FIG. 3 is a schematic exploded view of the lens module according to the first embodiment of the disclosure. FIG. 4 is a schematic combination view of a single lens module according to the first embodiment of the disclosure. FIG. 5 is a schematic cross-sectional view of a single lens module according to the first embodiment of the disclosure. Hereinafter, the manufacturing processes of the lens module and the element characteristics are illustrated, and the numerals of the elements are marked in the drawings, in which the same numerals of the elements represent the same elements.

In the manufacturing of the lens module 20, firstly, a substrate 210 having a first surface 211 and a second surface 212 is provided (S101). The substrate 210 is formed of a light transmissive material, e.g., glass. The second surface 212 is opposite to the first surface 211, and multiple lenses 213 are respectively disposed at a distance on the substrate 210. The multiple lenses 213 are arranged on the first surface 211 and/or the second surface 212 of the substrate 210 in accordance with different requirements. In this embodiment, the lenses 213 may be arranged in a form of convex lens or concave lens. In the lens module 20 of the first embodiment, the lenses 213 are arranged in the form of convex lens at a distance on the first surface 211 of the substrate 210, which is not limited to this form.

Then, a spacer 220 is formed on the substrate (S102). The spacer 220 is made of an opaque material, e.g., black heat resistance plastic, and is disposed on the second surface 212. The spacer 220 is disposed opposite to the lens 213 and surrounds the lens 213 to avoid blocking the lens from concentrating the light. The spacer 220 has a melting point higher than 200° C. and a CTE matching the CTE of the substrate 210. For example, when the material of the substrate 210 is glass, the CTE of the spacer 220 is not greater than 100 ppm/° C. (Parts Per Million/° C.), e.g., 100 ppm/° C., 60 ppm/° C. or 30 ppm/° C. Alternatively, the CTE α1 is lower than 50 ppm/° C. and the CTE α2 is lower than 100 ppm/° C., so that it may avoid a fracture occurred between the spacer 220 and the substrate 210 under the stress generated by the mismatch of the CTE of the substrate 210 and the spacer 220 during the operation of the lens module 20.

Therefore, the material of the spacer 220 has the characteristic of low CTE to match the CTE of the substrate, thereby reducing the stress generated by the mismatch of the CTE. Otherwise, the material of the spacer has a low CTE, and may be an opaque material such as liquid crystalline polymer (LCP) having a low CTE that is approximately lower than 30 ppm/° C., epoxy molding compound (EMC) having the CTE α1 and α2 respectively lower than 20 ppm/° C. and 60 ppm/° C. or polyetheretherketone (PEEK) having the CTE lower than 47 ppm/° C., but is not limited to the above-mentioned materials.

The spacer 220 may be obtained by injection molding, and multiple holes 221 are formed on the spacer 220. The holes 221 penetrate two opposite side surfaces of the spacer 220, and the positions of the holes 221 located on the spacer 220 are corresponding to the lenses 213 of the substrate 210 respectively. Meanwhile, the inner diameter of each of the hole 221 is slightly greater than the outer diameter of each of the lenses 213 (as shown in FIG. 3).

Then, an adhesive layer 230 is formed on the one side surface of the spacer 220 (S103), and a material forming the adhesive layer 230 may be a thermoset resin or an ultraviolet glue, but is not limited to the above-mentioned material. Then, the second surface 212 of the substrate 210 is disposed on the adhesive layer 230, or the adhesive layer 230 is attached to the second surface 212 of the substrate 210 (S104), so that the spacer 220 is bonded on the second surface 212 of the substrate 210 and the multiple holes 221 are corresponding to the multiple lenses 213, respectively. Therefore, the relative positions of the spacers 220 and the lenses 213 allow the spacers 220 to be disposed on the second surface 212 by surrounding a circumference of the lens 213. Then, the substrate 210 is cut along the clearance between the multiple lenses 213 (S105) to form multiple lens modules 20. As shown in FIG. 5, each of the lens modules 20 has a substrate 210, a spacer 220 and at least one lens 213. The lenses 213 are disposed on the first surface 211 of the substrate 210, and the spacers 220 are bonded on the second surface 212 of the substrate 210 by the adhesive layer 230. The spacers 220 are corresponding to the lenses 213 by the holes 221 and are disposed by surrounding a circumference of the lenses 213 at the relative positions on second surface 212.

The spacer 220 is manufactured by injection molding and then adhered to the second surface 212 by the adhesive layer 230 in the first embodiment. However, the above-mentioned embodiment is not intended to limit the method for bonding the spacer 220 and the substrate 210. In some embodiments, the spacer 220 may be enabled to directly contact and to be fixed on the second surface 212. For example, the material of the spacer 220 may be printed on the second surface 212 and the holes 221 are formed while printing. Then, the material printed on the second surface 212 is cured to form the spacer 220. For example, the method for enabling the spacer 220 to contact and to be fixed on the second surface 212 may be a lithography etching process to form the spacer 220 on the second surface 212.

Referring to FIG. 1 again, when the lens module 20 is applied to the image capturing module 10, the spacer 220 is bonded on the circuit board 110 by another adhesive layer 230′, so that the lens module 20 is supported on the circuit board 110 by the spacer 220 and is fitted on the image sensor 120 by the hole 221, and thus a distance is generated between the lens 213 and the image sensor 120 to suspend the lens module 20 over the image sensor 120 and the lens 213 is perpendicular to the image sensor 120. Now, as the image sensor 120 is surrounded by the lens module 20 and accommodated in an accommodation space formed between the substrate 210 and the spacer 220, the light coming from the ambient environment is propagated to the image sensor 120 merely through the lens 213 and the hole 221, and the spacer 220 shields the stray light coming from the ambient environment outside the lens module 20, thereby preventing the image sensor 120 from being influenced by the stray lights to reduce the performance and the quality of the image sensing.

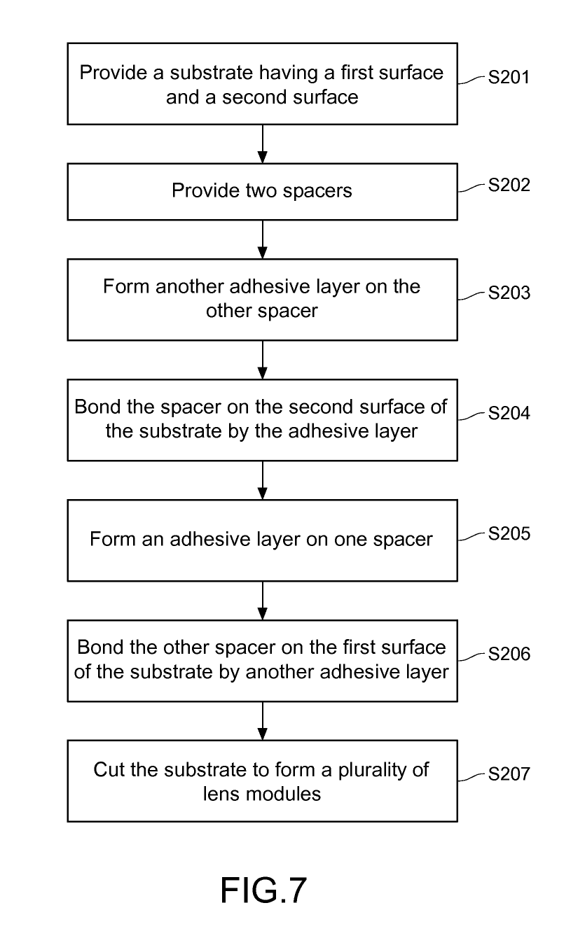

FIG. 6 and FIG. 7 illustrate the lens module 20 according to the second embodiment of the disclosure, and the difference between the second embodiment and the first embodiment lies in that the lens module 20 has two spacers 220 and 220′. The two spacers 220 and 220′ are disposed after the step of providing the substrate 210 during the manufacturing process of the lens module 20. Then, the adhesive layer 230 is respectively formed one surface of the two spacers 220 and 220′, or the adhesive layer 230 is respectively formed on the first surface 211 and the second surface 212 of the substrate 210, so that the two spacers 220 and 220′ are adhered to the first surface 211 and the second surface 212 of the substrate 210 respectively by the adhesive layer 230 and then the two spacers 220 and 220′ are bonded on the substrate 210 to form the lens module 20. In addition, the two spacers 220 and 220′ may be disposed in the same manner of the first embodiment, that is, the two spacers 220 and 220′ are provided (S202) after the step of providing the substrate 210 (S201). Then, an adhesive layer 230 is formed on one spacer 220 (S203), and the spacer 220 is disposed on the second surface 212 of the substrate 210 by the adhesive layer 230 (S204). Afterwards, before the step of cutting the substrate 210 (S207), an adhesive layer 230 is formed on the other spacer 220′ (S205), and the other spacer 220′ is disposed on the first surface 211 of the substrate 210 by the adhesive layer 230 (S206). Here, the two spacers 220 and 220′ are disposed on the lens module 20 in a different manner, which is not intended to limit the scope of the disclosure.

Similar to the description of bonding the spacer 220 on the second surface 212, the second embodiment should not be regarded as limitations of the method for bonding the spacers 220′ and the substrate 210. Likewise, the spacer 220′ may also be enabled to contact and to be fixed on the first surface 211 by printing or lithography etching process.

Based on the above-mentioned structure of the image capturing module, as the first surface and the second surface of the substrate both have the spacers disposed, when the lens module is applied to the image capturing module, both the two spacers shield the stray light coming from the ambient environment outside the lens module, thereby further improving the sensing performance and the quality of the image sensor.

In view of the above-mentioned description, the disclosure has the efficacies that with the opaque characteristic of the spacer, the lens module applied to the image capturing module may directly use the spacer to shield the outside stray light and omits the light shielding element such as the housing or the sunshade disposed in the conventional lens module, so the lens module of the disclosure reduces the volume of the lens module and the image capturing module. Meanwhile, the material forming the spacer has the characteristics of high melting point and low CTE, thereby preventing a fracture or damage occurred between the spacer and the substrate due to the mismatch of CTE during a lens module reflow process.

Meanwhile, in the manufacturing of the lens module, as compared with the conventional lens module that employs the spacer made of a glass material, the lens module of the present disclosure omits the disposing of the light shielding element such as the housing or the sunshade and in addition, the spacer may be formed by injection molding, thereby simplifying the manufacturing processes of the lens module and reducing the manufacturing cost of the lens module. The image sensor may be a complementary metal-oxide-semiconductor (CMOS) image sensor (CIS), and a charge coupled device image sensor, but is not limited to the above-mentioned sensor. The lens module may employ the product that fits the wafer process or may be formed during the manufacturing processes, so the lens module is not limited to the wafer-level lens module.

Moreover, the spacer may also be directly formed on the first surface and/or the second surface of the substrate where the spacer should be bonded without using other adhesive material. For example, the opaque material may be directly printed on the first surface and/or the second surface and then cured to form the spacer on the first surface and/or the second surface of the substrate, so that the spacer directly contacts the first surface and/or the second surface and is fixed on the first surface and/or the second surface. The similar techniques are well known to those skilled in the field of semiconductor process, and the details will not be illustrated herein.

What is claimed is:

1. A lens module, suitable for a wafer-level process and working in collaboration with an image sensor to allow a light to appropriately concentrate on the image sensor through the lens module, the lens module comprising:
a substrate, having a first surface and a second surface opposite to each other;
a lens, disposed on the first surface or the second surface, for concentrating the light; and
a spacer, disposed on the second surface, wherein the spacer is opposite to and surrounding the lens, for avoiding blocking the lens from concentrating the light;
wherein the substrate and the lens are made of a light transmissive material and the spacer is made of an opaque material.

2. The lens module according to claim 1, wherein a material forming the spacer is selected from among liquid crystalline polymer (LCP), epoxy molding compound (EMC) and polyetheretherketone (PEEK).

3. The lens module according to claim 1, wherein the coefficient of thermal expansion (CTE) of the spacer and the CTE of the substrate are not greater than 100 ppm/° C.

4. The lens module according to claim 1, further comprising another spacer, disposed on the first surface of the substrate, wherein the two spacers are disposed opposite to the lens and surround the lens, for avoiding blocking the lens from concentrating the light.

5. The lens module according to claim 1, further comprising an adhesive layer, located between the spacer and the substrate, wherein the spacer is bonded on the substrate by the adhesive layer.

6. A method for manufacturing a lens module, suitable for a wafer-level process, wherein the lens module works in collaboration with an image sensor to allow a light to appropriately concentrate on the image sensor through the lens module, the manufacturing method comprising:
providing a substrate, wherein a plurality of lenses are disposed on a first surface or/and a second surface of the substrate;
disposing a first spacer on the second surface of the substrate, wherein the first spacer is disposed opposite to the lenses and surrounds the lenses; and
cutting the substrate to form a plurality of lens modules, wherein each of the lens modules has at least one lens.

7. The method for manufacturing the lens module according to claim 6, wherein before the step of cutting the substrate, the method further comprises disposing a second spacer on the first surface of the substrate.

8. The method for manufacturing the lens module according to claim 7, wherein the step of disposing the second spacer further comprises:
bonding the second spacer on the first surface of the substrate by an adhesive layer.

9. The method for manufacturing the lens module according to claim 7, wherein the step of disposing the second spacer further comprises:
enabling the second spacer to directly contact and to be fixed on the first surface of the substrate.

10. The method for manufacturing the lens module according to claim 7, wherein the step of disposing the first spacer further comprises:
enabling the first spacer to directly contact and to be fixed on the second surface of the substrate.

11. The method for manufacturing the lens module according to claim 6, wherein the step of disposing the first spacer further comprises:
bonding the first spacer on the second surface of the substrate by an adhesive layer.
